(19) United States
(12) Patent Application Publication
(10) Pub. No.: US 2008/0314336 A1
(43) Pub. Date: Dec. 25, 2008

(54) Portable Restraint System

(76) Inventors: Alana Catharine Church, Lenoir, NC (US); Isaiah Monty Simmons, Lenoir, NC (US)

Correspondence Address: SIMMONS PATENTS, P.O. BOX 1560, LENOIR, NC, 28645, US

(21) Appl. No.: 12/143,795

(22) Filed: Jun. 22, 2008

Related U.S. Application Data
(60) Provisional application No. 60/945,596, filed on Jun. 22, 2007.

(51) Int. Cl. A01K 15/04; A01K 27/00; B60R 22/18

(52) U.S. Cl. 119/771; 119/769; 119/792

(57) ABSTRACT

The present invention relates to an apparatus and method of restraining a body. One embodiment of the invention includes portable surface configured with a latching interface a predefined distance from the edges of the portable surface. The system includes a tether for mechanically a body with the latching device. The length tether that is shorter than the predefined distance from the edges. Certain embodiments include a collapsible surface for ease of storing and transporting, a sensor mechanically associated with the latching device for activating an electronic device, and a collapsible housing.

### CLAIM TO PRIORITY

This application claims priority to provisional application 60/945,596 filed on Jun. 22, 2007, the entire contents of which are incorporated herein by this reference for all purposes.

### TECHNICAL FIELD OF THE INVENTION

The present invention relates to an apparatus and method of restraining a body including animals such as dogs, cats, and horses. One embodiment of the invention includes portable surface configured with a latching interface disposed a predefined distance from the edges of the portable surface.

### BACKGROUND OF THE INVENTION

Animal restraint systems are well known and many varying types of restraint systems have been developed. Such restraint systems include human, canine, and feline restraints configured to limit the movement of such animals. One such system was developed by Canine Auto Restraint Equipment (CARE). CARE claims to have developed several canine restraint systems a seat belt restraint system and other similar systems. Such a system is disclosed in Smith et al. U.S. Pat. No. 7,357,099 issued on Apr. 15, 2008 (incorporated by this reference for all that it discloses). Smith et al. discloses such an animal restraining device for use in a vehicle where an animal is secured through the use of round-bars, tie bars, seat belts, and a stand-alone leash. A similar restraint system is disclosed in U.S. Pat. No. 5,794,571 issued to Goldberg (incorporated by this reference for all that it discloses).

While such a restraint system works well for its intended purposes, it has it issues. Notably, such systems use a lease/tether connected to either a traditional dog collar or to the top/side of a dog harness. As a result, the effectiveness and usable configurations of such systems are limited. For example, such restraint systems typically need to be used with a vehicle. Once a pet is removed for a vehicle environment, such restraint systems lose most, if not all, of their restraint characteristics.

What is needed is a restraint system that provides for an improved harness having a restraint interface on the underside of a harness and that provides more universal functionality so that the restraint system continues to provide restraint functionality separate form a vehicle or room in which is may be used.

### SUMMARY

Some of the objects and advantages of the invention will now be set forth in the following description, while other objects and advantages of the invention may be obvious from the description, or may be learned through practice of the invention.

Broadly speaking, a principle object of the present invention is to provide a portable apparatus for restraining a body, including dogs, cats, and cattle.

Yet another object of the invention is to provide a portable apparatus for transporting, for restraining a body comprising a tether mechanically associated with a latching device wherein the latching device is further mechanically associated with a surface a predefined distance from the edges of the surface and wherein the length of the tether is less than such predefined distance.

Still another object of the invention is to provide a portable apparatus for restraining a body comprising a collapsible surface.

Yet another object of the invention is to provide a portable apparatus for restraining a body comprising a collapsible surface.

Another object of the invention is to provide a portable apparatus for transporting, for restraining a body comprising a tether mechanically associated with a latching device wherein the latching device is further mechanically associated with a surface a predefined distance from the edges of the surface and wherein the length of the tether is less than such predefined distance and wherein the tether is mechanically associated with a sensor configured for activating an electronic device.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps, or features hereof may be practiced in various uses and embodiments of this invention without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures or stated in the detailed description).

One exemplary embodiment of the present invention relates a portable apparatus for restraining a body such as a dog. The apparatus comprises generally horizontally extending surface wherein the ends of such surface define peripheral edges. The surface is mechanically associated with a latching device disposed a predefined distance from the peripheral edges. Notably, the predefined distance from such peripheral edges may or may not be equal. The latching device is configured to receive a tether. The tether is shorter in length than the shortest distance from the latch to a peripheral edge.

For one embodiment, the surface comprises a plurality of collapsible sections which may be folded to reduce the surface area of the surface. The apparatus may further comprise a housing that is also collapsible.

Another exemplary embodiment may further comprise at lease one of edge connector and/or edge receiver. The edge connector is configured for being mechanically associated with an edge receiver there by allowing a first surface comprising an edge connector to be mechanically associated with a second receiver comprising an edge receiver.

The surface system may further comprise an electronic module for performing a plurality of tasks. One such module may be a tether sensor that sense the amount of pull-force a body connected to the tether is applying to the latch. When a predefined maximum pull-force is reached, a plurality of tasks may be activated including activating a shock collar, activating a sound device, transmitting a data signal, and activating monitoring devices.

An electronic module may further be electrically associated with an electronic tether lock. For this embodiment of the invention, electronic tether lock comprise a low power receiver configured for receiving a unlock data signal. When the unlock data signal is received, the electronic lock releases its mechanical association with the tether thereby freeing a body connected to the tether. The unlock data signal may be generated by a plurality of devices including a home monitoring system. For example, a home monitoring system may generate a unlock data signal when a fire is detected, a “burglar alarm sensor” is activated, a predefined time is reached, or by an electronic device that monitors environmental parameters such as temperature.

The system may further comprise a recording device for recording voice and video messages. For example, a dog owner may record the voice message “NO”. Such messages may be activated when, for example, when said predefined maximum pull-force is detected. Additionally, if the system does not detect a pull-force in excess of the predefined maximum pull-force for a predefined amount of time after generating the above described “NO” message, the system may be further operable to activate a positive-reinforcement device, such as a food dispenser.

The surface may be further associated with wheels to facilitate easy transportation of the surface and associated body.

Yet another embodiment of the invention relates to methodology for providing a portable apparatus for restraining a body, including dogs, cats, and cattle.

Additional embodiments of the present subject matter, not necessarily expressed in this summarized section, may include and incorporate various combinations of aspects of features or parts referenced in the summarized objectives above, and/or features or components as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is an elevated side perspective view of a body mechanically associated with a portable surface according to one exemplary embodiment of the invention;

FIG. 2 is an elevated side perspective view of a body mechanically associated with a portable surface according to one alternative exemplary embodiment of the invention;

FIG. 3 is an elevated side perspective view of two portable surfaces mechanically associated with each other and further comprising a tether module according to one alternative exemplary embodiment of the invention comprising multiple collapsible sections;

FIG. 4 is an elevated side perspective view of a body mechanically associated with a portable surface comprising wheels;

FIG. 5 is an elevated side perspective view of a collapsible cage;

FIG. 6 is an elevated side perspective view of a body mechanically associated with a portable surface comprising a collapsible housing according to one alternative exemplary embodiment of the invention;

FIG. 7 is a side perspective view of the apparatus depicted in FIG. 6 in a collapsed position;

FIG. 8 is another alternative embodiment of the invention comprising a portable surface with mooring interfaces where the surface is mechanical with the underside of an animal harness;

FIG. 8b is a close up view of area 80 shown in FIG. 7;

FIG. 9 depicts the embodiment of the invention shown in FIG. 8 associated with a vehicle seat and including support arms;

FIG. 9b is a side perspective view of the invention including electronic modules; and

FIG. 10 is a block diagram representation of the various components that may be incorporated in an electronic module associated with the apparatus according to one alternative exemplary embodiment of the invention.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only, and is not intended as limiting the broader aspects of the present invention.

For the purposes of this document two or more items are “associated” by bringing them together or into relationship with each other in any number of ways including a direct or indirect physical connection that may be a permeate connection, a temporary or releasable connection, a ridged connection or a connection that allows relative movement between the items being associated with each other. Similarly, two or more items are “electrically associated” by bringing them together or into relationship with each other in any number of ways including: (a) a direct, indirect or inductive communication connection, and (b) a direct/indirect or inductive power connection.

This document contains headers. Such headers are “place markers” inserted for the convenience of a reader and have no other meaning or affect the construction of this document in any way and should not to be used in the construction of this document.

While the particulars of the present invention and associated technology may be adapted for use with restraining any animal, the examples discussed herein are primarily in the context of restraining pets. For the purpose of this document, humans are animals.

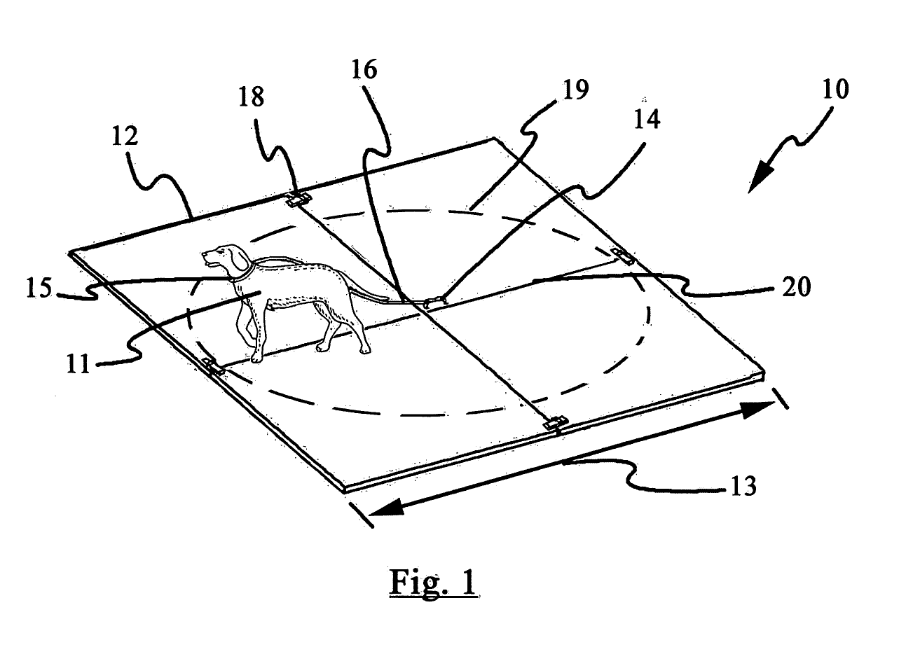

Referring now to FIG. 1, one exemplary embodiment of an animal restrain device ARD (10) is presented. ARD (10) comprises a rectangular base structure defining a substantially flat surface (12) having sides of length (13). It should be appreciated that surface (12) may define other geometric shapes (e.g. a circle) without departing from the scope and spirit of the invention. For the configuration depicted in FIG. 1, surface (12) is composed of four equal sections that may be folded to allow for easier transportation and storage. When folded, latching-interface (14) may be used as a handle for carrying ARD (10).

In the approximate center of ARD (10) is a latching-interface (14) configured for being mechanically associated with a tether (16). As shown in FIG. 1, one end of tether (16) is mechanically associated with latching-interface (14) and the opposing end is mechanically associated with animal restraint (15). For the presently preferred configuration, animal restraint (15) is a dog collar and tether (16) is leash. The length of tether (16) is less than one-half the distance defined by length (13). Restated, the maximum length of tether (16) is less than the shortest distance from the latching-interface (14) and an edge of flat surface (12). In addition, while the size of surface (12) may be selected according to the needs/desires of a user, for the embodiment shown in FIG. 1, the length (13) of the base structure is not less twice the length of animal (11). For other configurations depicted later, minimum length (13) may be reduced to not less than the length of the animal.

For such a configuration, animal (11) will not be able to move beyond the distance defined by circle (19). One of ordinary skill in the art will appreciate that such animal (11) will not be able to move surface (12) or beyond surface (12) as animal (11) cannot reach traction surface separate from surface (12). Thus, animal (11) is restrained by the system.

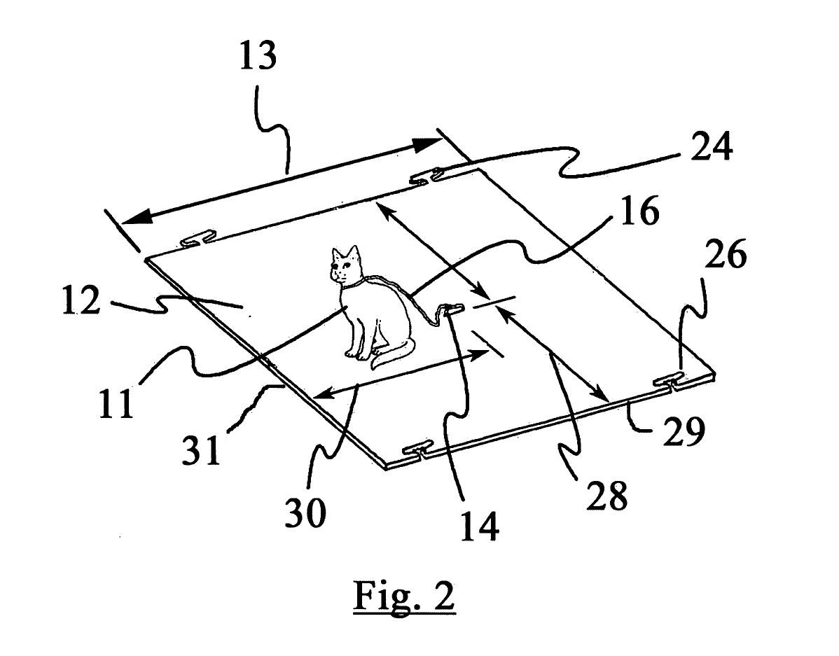

Referring now to FIG. 2, an alternative embodiment of the invention is presented. ARD (10) is a one piece structure comprising a substantially flat surface (12) configured in a rectangular shape defined by side (31) and side (29). The length of side (29) is twice the distance of length (28) and the length of side (31) is twice the distance of length (30). Therefore, as depicted in FIG. 2, latching-interface (14) is again disposed in the approximate center of ARD (10). The length of tether (16) is equal to or less than the shorter of length (30) or length (28). For such a configuration, animal (11) is again restrained from leaving surface (12). It should be appreciated that for this embodiment, the length of side (31) is not necessarily equal to the length of side (28).

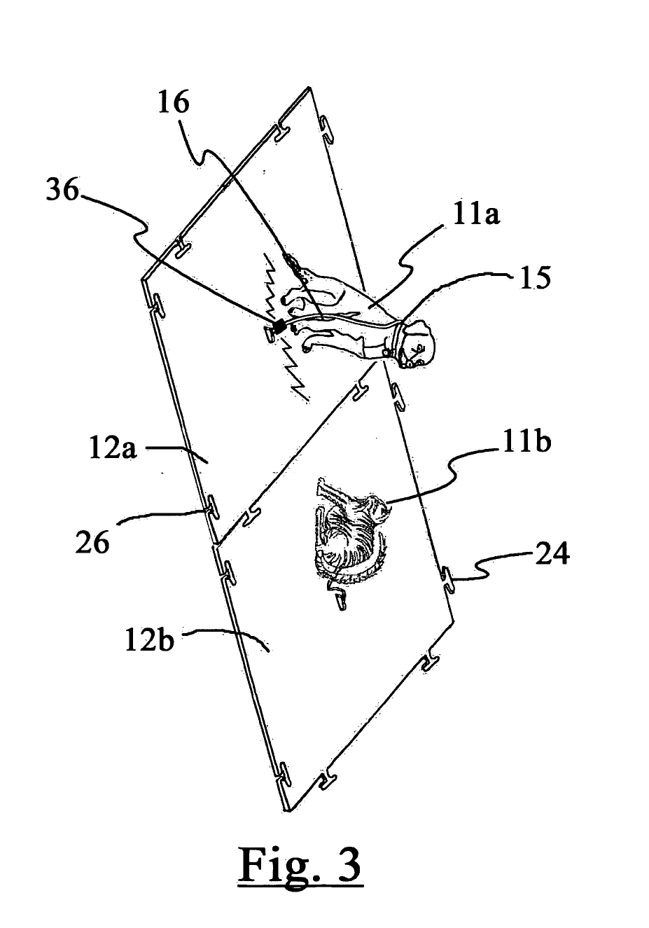

Referring now to FIG. 2 and FIG. 3, for the presently preferred embodiment of the invention, surface (12) is configured with male-surface-interface (24) and female-surface-interface (26). Such surface interfaces are configured for being mechanically associated with other ADR (10) devices to form an interlocking structure. It should be appreciated that side (31) and side (29) may also be associated with surface interfaces as shown in FIG. 3.

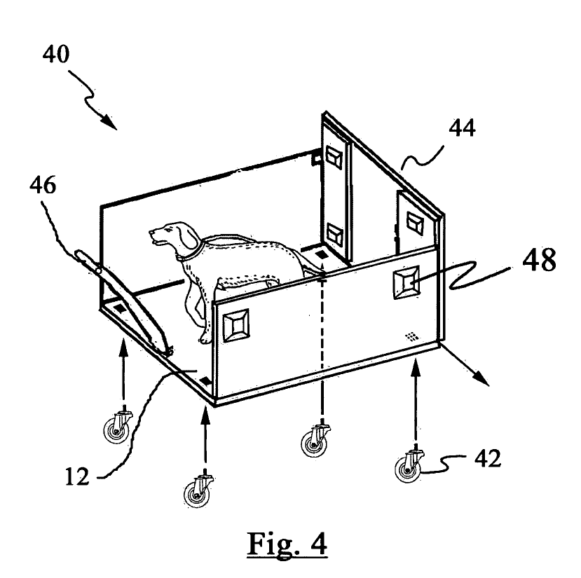

Referring now to FIG. 4, another alternative embodiment of the invention is presented. For the embodiment in FIG. 4, ARD (10) is associated with movement-facilitators (42). For the present embodiment, movement-facilitators (42) are wheels. ARD (10) is further configured with handle (46) configured to assisting in the movement of ARD (10). Handle (46) may or may not be removably associated with surface (12). Additional, surface (12) may be further configured with walls (44) for forming a type of cage structure. Walls (44) may further be configured to fold down to form a more flat surface. When placed in the folded down configuration, offsets (48) support walls (44) so that they are at substantially the level as surface (12).

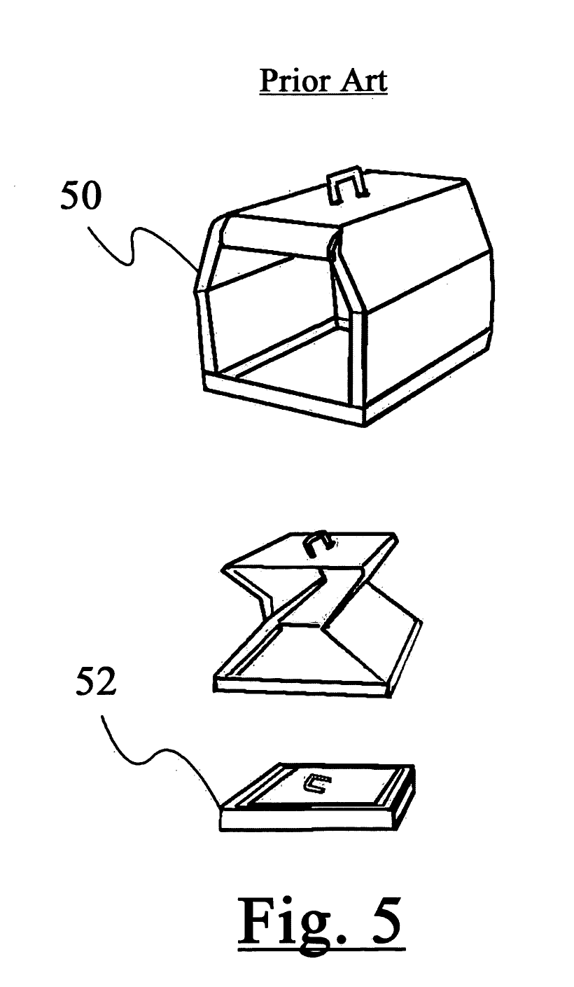

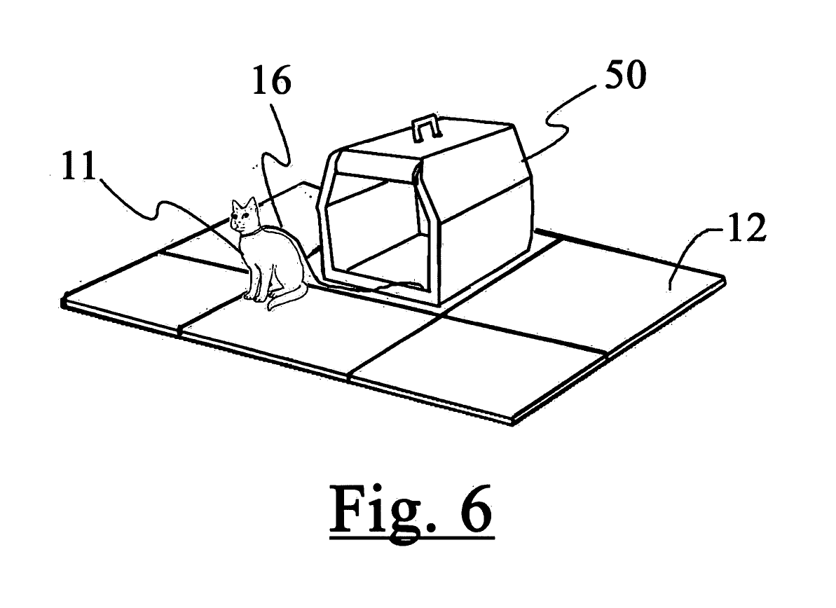

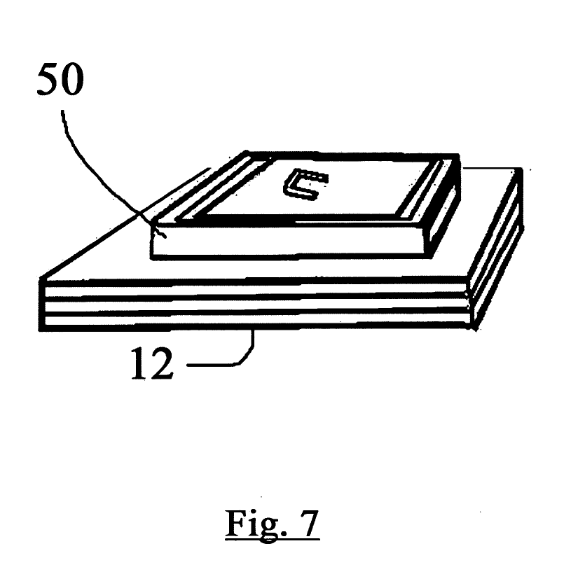

Referring now to FIG. 5, FIG. 6, and FIG. 7, an alternative embodiment of the invention is presented. For the presently preferred embodiment, ARD (10) is configure with (or for receiving) a prior art collapsible cage (50). As shown in FIG. 6, collapsible cage (50) is associated with surface (12). Surface (12) comprises a plurality of foldable sections allowing the presently preferred embodiment to be collapsible as depicted in FIG. 7. It should be appreciated that surface (12) may comprise any number of sections including only one section. In addition, latching interface (14) is preferably positioned inside cage (50) and at the approximate center of surface (12).

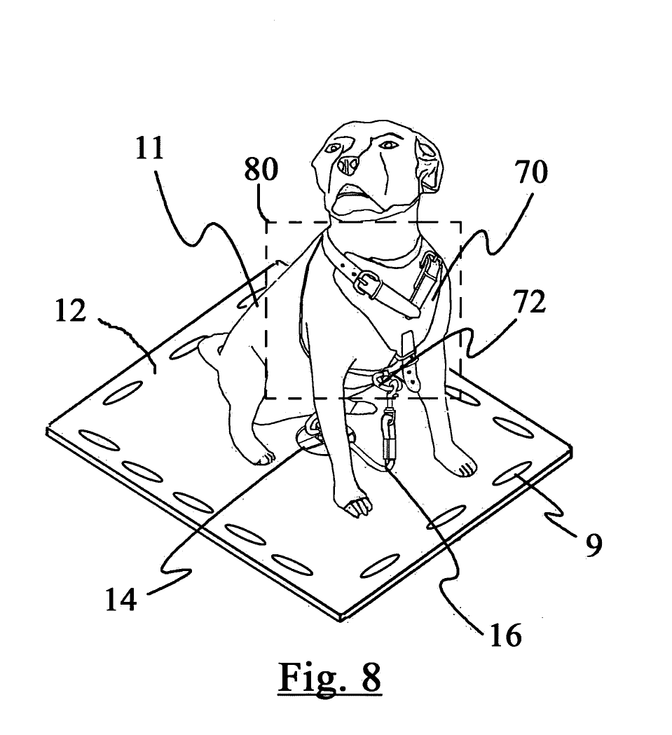

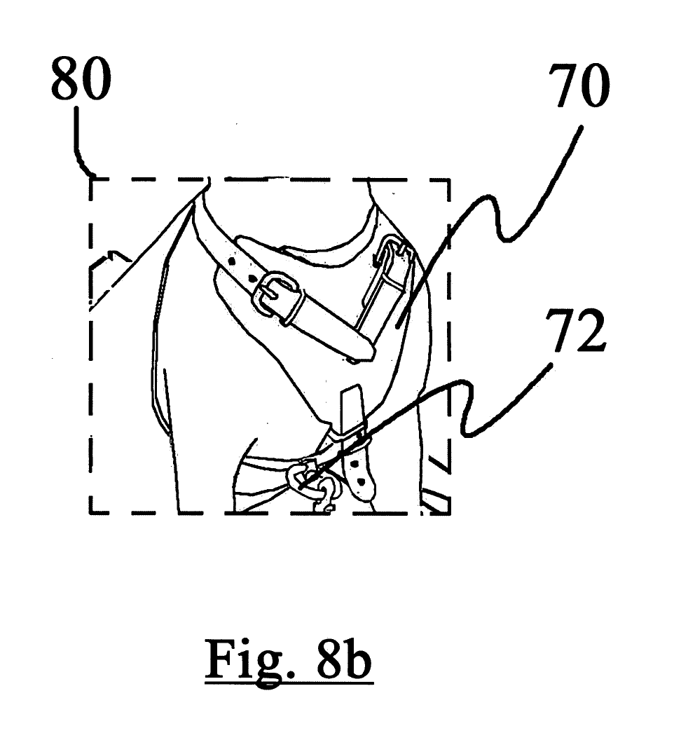

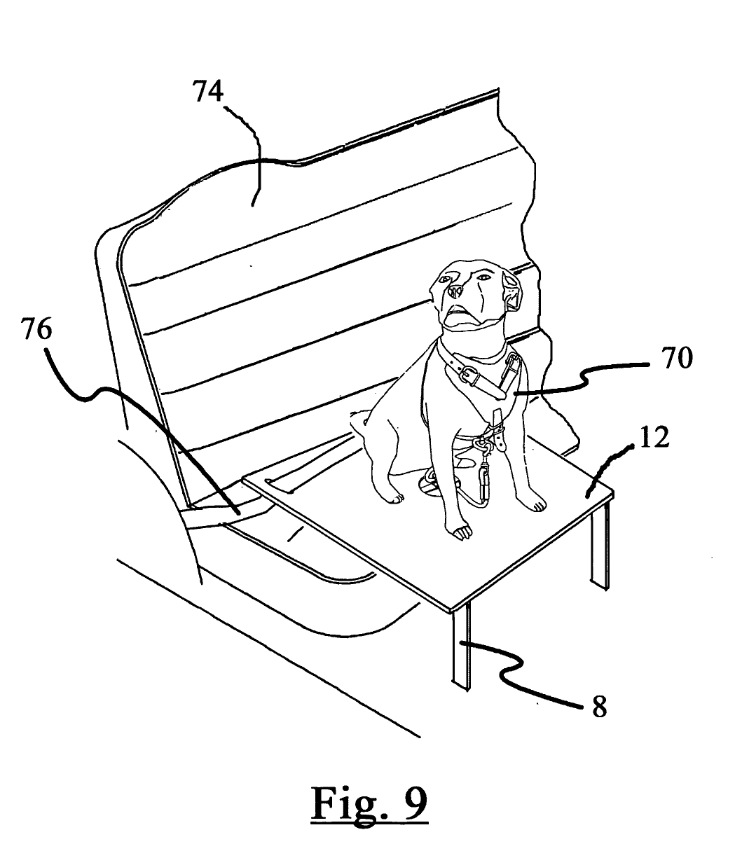

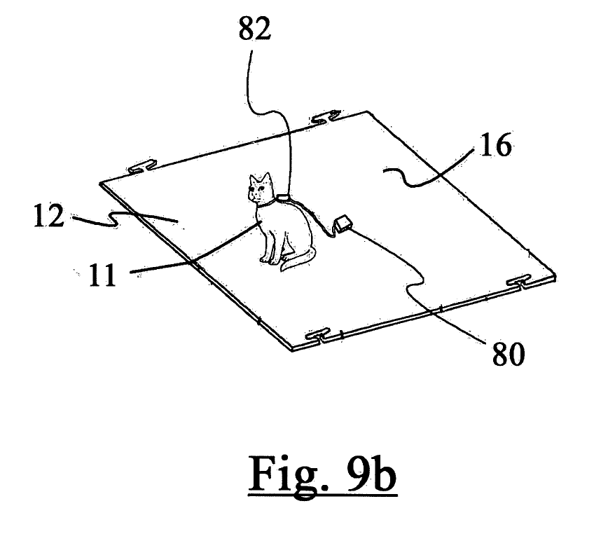

Referring now to FIG. 8 and FIG. 9, another alternative embodiment of the invention is presented. For the presently preferred embodiment, animal (11) is associated with restraint (70) restraint-interface (72) via one of tether (16). The opposing end of tether (16) is associated with tether-interface (14) disposed in the approximate center of surface (12). The length of tether (16) is selected to prevent animal (11) from leaving surface (12). For some embodiments, tether (16) is adjustable to allow for customer tether (16) length as desired by a user.

On of ordinary skill in the art will appreciated that the ARD (10) device depicted in FIG. 8 allows for a more compact surface (12). For such a configuration, a surface (12) can be placed on a pet owner's desk (particularly useful for small dogs), in the middle of a living room floor, in the bed of a truck, on the floor of an RV (recreational vehicle), or in the back seat of a car. Additionally, larger animals can be secured using ARD (10) such as horses, cows, bulls and many other animals.

Along the perimeter of surface (12) are a plurality of mooring interfaces (9) configured for receiving a securing device (76). The securing device (76) is configured for associating ARD (10) with the surface of another item (e.g. a desk top, a vehicle seat, a floor of a car or vehicle, the bed of a truck, etc.). It should be appreciated that any surface (12) may define any number of mooring interfaces (9) including only one. For the embodiment depicted in FIG. 8, mooring interfaces (8) are holes that allow a securing device to be passed through the holes. Other types of mooring interfaces types may be used such as tie offs, and magnetic interfaces.

As shown in FIG. 9, securing device (76) is a seat belt and the “other item” is a vehicle seat (74). For some embodiments, surface (12) may further be associated with support legs (8) to allow surface (12) to be disposed on a surface that is not large enough to support all of surface (12).

Referring now to FIG. 8b, one exemplary embodiment of a restraint (70) is presented. Restraint (70) is a harness. Such harness is similar to prior art device except it has a restraint-interface (72) on the underside of the harness. Such harness preferably has a loop that surrounds the torso of an animal with connecting straps between them for reinforcement. Such a=design allows for distribution of force along a body to minimize choking and reduce the risk of slipping out of the restraint.

### Logic/Control Units

Referring now to FIG. 9b, it should be appreciated that ARD (10) may be associated with a control unit (80) configured to perform a plurality of functions. For the preferred embodiment, restraint (70) or restraint (15) (depending on the configuration of interest) is associated with tether (16) via an electronic tether-lock (82). For such an embodiment, either tether (16) comprises communication conductors or control unit (80) is on wireless communication with tether-lock (82). The status of tether-lock (82) is configured to be verified and changed using control unit (80). In addition, restraint (15, 70) may be configured with training features such as shock devices. One such device is a shock collar. Shock collars are well known by those of ordinary skill in the art and a detailed description thereof is not necessary to provide an enabling description of the invention. As described above for tether-lock (82), communications between control unit (80) and restraint (15, 70) may be wired or wireless.

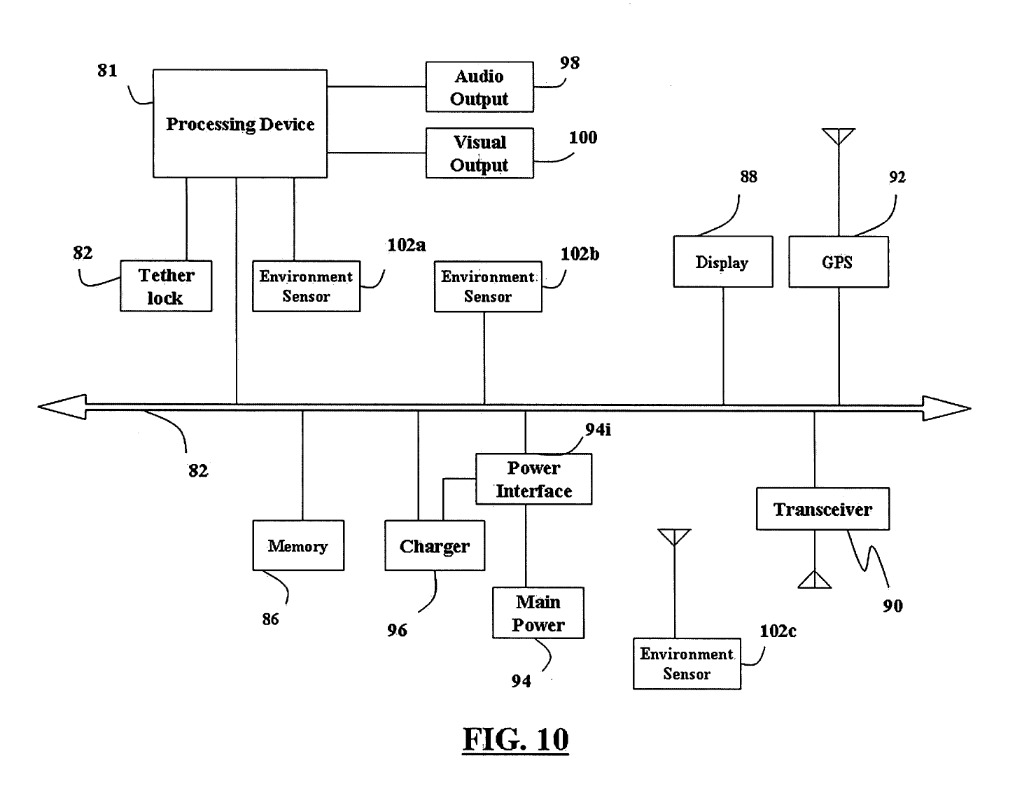

Referring now to FIG. 10, attention will now be directed more specifically to one exemplary embodiment of a control unit (80). Initially it should be appreciated that FIG. 10 presents just one of a plurality of methods of electrically associating the various electronic components to achieve the features desired for control unit (80). For example, FIG. 10 presents the use of a buss (81) for electrically associating the various components. It should be appreciated that embodiments where certain devices are directly electrically associated with a microcontroller without the use of a buss fall within the scope of the invention.

The functional blocks of FIG. 10 represent ASSPs (Application Specific Standard Product), Complex Programmable Logic Devices (CPLD), ASICs (application specific integrated circuit), microprocessors, or PICs. In addition, one or more functional blocks may be integrated into a single device or chip sets such as ASSP chip sets. For example, one or more of the various interfaces described below may be integrated into (or have its described functions performed by) control unit (80).

Manufactures of suitable ASSP devices include Motorola, and Texas Instruments. While most of the functions are preferably performed by ASSP chip sets, Complex Programmable Logic Devices (CPLD) may be used to interface the various ASSP blocks to system buss (81) allowing one system component to interface with another component. Manufactures of suitable CPLD devices include Lattice's (ispMACH 4000 family) and (Altera's MAX 7000-series CPLD).

For the presently preferred embodiment of the invention, processing device (81) is configured for controlling the various features of control unit (80) including the data management system (including flow data), communication system, power management system, alarm system, and environmental sensor system. Processing device (81) is preferably a simple PIC (such as the ones manufactured by MicroChip). Other technologies that may be used include ASICs (application specific integrated circuit) and ASSPs (application specific standard product). Processing device (81) may comprise onboard ROM, RAM, EPROM type memories. As shown in FIG. 10, processing device (81) is electrically associated with buss (81).

Buss (81) is configured for providing a communication path between the various electronic devices electrically associated with buss (81). For example, Buss (81) is configured for transferring data signals between processing device (81) and other electronic devices electrically associated with buss (81). For the preferred embodiment, bus (102) also comprises electrical paths for transferring power between main power (94), and EM energy converter (not shown) and other electronic devices electrically associated with buss (81). Buss (81) my further comprise a data port and or a power port configured for supplying/receiving power or providing a communication path to electronic devices electrically associated with such port (such as a programmer).

A memory (86) is electrically associated with buss (81) and may be any type of memory suitable for storing data such as flash memory, SRAM memory, hard drive memory, as well as other types of memories. Volatile memory continuously connected to a power source may be used, although, for the preferred embodiment, memory (86) is nonvolatile memory. Memory (86) may be used for storing all types of data including application programs, sound data, animal information, sensor data, threshold data, and warning-criteria. Memory (86) is electrically associated with processing device (81) via memory buss (81).

Optional Display (88) is configured for displaying the various system data received or generated by devices electrically associated with buss (81). For the preferred embodiment display (88) is a LCD display.

For one alternative embodiment of the invention, control unit (80) comprises transceiver (90) comprising a relatively low power transmitter that transmits a data signal in an unlicensed frequency band. Suitable technologies include Bluetooth and Zigbee (IEEE 802.15). Zigbee is a low data rate solution for multi-month to multi-year battery life applications. Zigbee operates on an unlicensed, international frequency band. Such technologies are known and understood by those skilled in the art, and a detailed explanation thereof is not necessary for purposes of describing the method and system according to the present invention. Low power transceiver (90) is configured for short range communication with other suitably configured devices.

Other embodiments include a relatively longer range transmitter comprising any number of well known technologies for wireless communications transmitting at any legal power level. For example, transceiver (90) may be configured to communicate over GPRS, GSM, GPRS, 3G, and EDGE enabled networks as well as WAP networks.

Control unit (80) may further be configured for storing and/or generating location data. For embodiments that generate location data, control unit (80) includes a GPS device (92) electrically associated with processing device (81) via buss (81). GPS (92) is one embodiment of a locator electrically associated with a processing device where GPS (92) is configured to generate location-data. Alternatively, GPS (92) may be incorporate in restraint (15, 70) or tether-lock (82) along with a transceiver for transmitting location data to a remote location.

The attributes of exemplary main power (94) are now considered. For the presently preferred embodiment, main power (94) is a long life depletable power source such as a Li Ion battery. For such embodiment, main power (208) comprises at least one long life rechargeable Li Ion battery such as the ones manufactured by A123 Systems®.

Extending the life of main power (94) or extending the time between recharging is one design concern addressed by power interface (94i). Power Interface (94i) is configured to perform power management functions for the system as well as monitor the status of main power (94) and report such status to devices electrically associated with buss (81) (such as processing device (81)). Power interface (94i) dynamically addresses power management issues by selectively powering down unutilized devices. For the preferred embodiment, power interface (94i) is a CPLD that generates chip-select signals and powers down the various ASSPs as desired. Alternatively, processing device (81) may perform such power management functions.

Attention now is directed to audio output (98) and visual output (100). For the preferred embodiment, audio output (98) comprises a sound generator such as a sound transducer. Audio output (98) is configured for generating sound waves to attract the attention of a user or to issue audio signals to an animal. For example, audio output (98) may be configured to emit a beeping sound.

For the presently preferred embodiment, visual output (100) comprises a light generator such as a LED. Visual output (100) is configured for generating a visual signal to attract the attention of a user or an animal. Processing device (81) may be configured to use either or both outputs to in an attempt to attract the attention of a user or to send signals to an animal. It should be appreciated that visual outputs (100) may be associated with surface (12), tether (16), control unit (80), and restraint (15, 70) and may be in wired or wireless communication with processing device (81).

Environment Sensor (102) is electrically associated with processing device (81). For the presently preferred embodiment, environment sensor (102) is at least one of a light sensor, temperature sensor, sound sensor, fluid sensor, smoke sensor, fire sensor, and CO2 sensor. Any number and type of sensor may be electrically associated with processing device (81) without departing from the scope and spirit of the invention.

### Electronic Features

The electronic features of the invention are now considered. For one embodiment, an animal (11) is associated with surface (12) via a tether-lock electrically associated with control unit (80). Control unit (80) is configured to monitor the animal's environment and take action upon detecting a predefined environmental condition.

Where environment sensor (102) is a temperature sensor, processing device (81) monitors the temperature data generated by sensor (102) and when such data is outside a predefined temperature threshold value, a control signal is generated. For example, the upper temperature threshold may be set to 90 degrees. When processing device (81) determines that the data generated by sensor (102) represents temperature data for a temperature above 90 degrees, processing device (81) is configured to transmit a control signal using transceiver (90) or a wired connection. Such a control signal may be to start a car and turn on the climate control system or to lower a window. When processing device (81) determines that a lower threshold is passed, a control signal requesting heat by be generated and transmitted.

Where environment sensor (102) is a smoke detector, processing device (81) may be configured to generate the control signal to open tether-lock (82) to allow an animal to escape the smoke. Processing device (81) may further generate and transmit smoke-detected-signals and transmitted such signals to a remote device.

The electronic tether-lock (82) may be opened under other conditions. For one embodiment, control unit (80) is in communication with a security system. When such security system detects an intruder or other predefined condition, such security system generates and transmits an unlock signal to control unit (80). Control unit (80) further generates the necessary signal to open tether-lock (82) freeing the animal.

Tether-lock (82) may further be associated with an electronic pull-force sensor configured to generate force data consistent with the amount of force an animal is placing on tether (16). When the pull force exceeds a predefined maximum pull-force, processing device (81) may generate signals to activate a plurality of tasks including activating a shock collar, activating a sound device, transmitting a data signal, and activating monitoring devices.

The system may further comprise a recording device for recording voice and video messages. For example, a dog owner may record the voice message “NO”. Such messages may be activated when, for example, when said predefined maximum pull-force is detected. Additionally, if the system does not detect a pull-force in excess of the predefined maximum pull-force for a predefined amount of time after generating the above described “NO” message, the system may be further operable to activate a positive-reinforcement device, such as a food dispenser.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A portable animal restraint system comprising:
a base structure defining a substantially flat surface;
a latching-interface disposed in the approximate center of said base structure, said latching-interface configured for being mechanically associated with a tether;
a tether having a first end and an apposing second end wherein said first end is mechanically associated with said latching-latching interface and wherein the length of said tether is less than the shortest distance from said latching-interface and an edge of said flat surface; and
wherein the second end of said tether is configured for being mechanically associated with an animal restraint device.

2. A portable animal restraint system as in claim 1, wherein said tether is a leash and said animal restraint device is an animal collar.

3. A portable animal restraint system as in claim 2, wherein said shortest distance is about twice the length of the animal to be restrained.

4. A portable animal restraint system as in claim 2, wherein said base structure comprises a plurality of sections configure to be folded so that said latching-interface may be used as a handle to carry said base structure.

5. A portable animal restraint system as in claim 1, wherein said restraint system further comprises an animal restraint defining a harness with a restraint-interface disposed on the underside of said harness.

6. A portable animal restraint system as in claim 5, wherein said shortest distance is about the same as the length of the animal to be restrained.

7. A portable animal restraint system as in claim 4, further comprising at least one mooring interface configured for being associated with a securing device associated with a second surface.

8. A portable animal restraint system as in claim 7, wherein in said at least one mooring interface is an opening defined by said base structure.

9. A portable animal restraint system as in claim 8, wherein said base structure is further associated with support arms.

10. A portable animal restraint system as in claim 1, wherein a section of said surface is associated with a collapsible cage so that said latching-interface is disposed at least partially within said collapsible cage.

11. A portable animal restraint system comprising:
a base structure defining a substantially flat surface;
a latching-interface disposed in the approximate center of said base structure, said latching-interface configured for being mechanically associated with a tether;
a harness with a restraint-interface disposed on the underside of said harness;
a tether having a first end and an apposing second end wherein said first end is mechanically associated with said harness and wherein the length of said tether is less than the shortest distance from said latching-interface and an edge of said flat surface.

12. A portable animal restraint system as in claim 11, wherein said shortest distance is about the same as the length of the animal to be restrained.

13. A portable animal restraint system as in claim 11, wherein said base structure further defines at least one opening for receiving a securing device associated with a second surface.

14. A portable animal restraint system as in claim 11, wherein said second surface is one of the seat of a vehicle and the floor of a vehicle and the bed of a truck.

15. A portable animal restraint system as in claim 11, wherein said harness further comprises:
a first loop configured to surround the neck of an animal;
a second loop configured to surround the torso of said animal;
at least one connecting strap mechanically associating said first loop with said second loop; and
at least one latching-interface disposed on at least one of the top of said harness and the side of said harness.

16. A portable animal restraint system configured so that the restraint system may be carried by a person when not in use, said portable restraint system comprising:
a base structure defining a substantially flat surface;
a latching-interface disposed in the approximate center of said flat surface, said latching-interface configured for being mechanically associated with a tether;
a harness comprising a first loop configured to surround the neck of an animal and a second loop configured to surround the torso of said animal wherein said first loop and said second loop are mechanically associated by at least one connecting strap;
a first restraint-interface disposed on the bottom of said harness and a second restraint-interface disposed on one of the top of said harness and the side of said harness;
a tether having a first end and an apposing second end wherein said first end is mechanically associated with said first restraint-interface and said second end is mechanically associated with said second restraint-interface; and
wherein the shortest distance from the latching-interface to any side of said flat surface is about equal to the length of the animal to be restrained and wherein the length of said tether is less than said shortest distance.

17. A portable animal restraint system as in claim 16, wherein the length of said tether is about equal to the length of the legs for the animal to be restrained.

18. A portable animal restraint system as in claim 16, further comprising at least one mooring interface.

19. A portable animal restraint system as in claim 16, wherein said mooring interface is a seat beat buckle receiver configured for being mechanically associated with a vehicle seat belt.

20. A portable animal restraint system as in claim 17, further comprising a collapsible cage associated with said flat surface.
